(19) United States
(12) Patent Application Publication
(10) Pub. No.: US 2024/0265149 A1
(43) Pub. Date: Aug. 8, 2024

(54) METHOD FOR VERIFIABLY DOCUMENTING INFORMATION

(71) Applicant: ADAPA DIGITAL GESMBH, Wiener Neudorf (AT)

(72) Inventors: Thomas LANGTHALER, Wien (AT); Stefan ZOISTER, Nußdorf am Attersee (AT); Stephan KLEEBINDER, Wien (AT)

(73) Assignee: ADAPA DIGITAL GESMBH, Wiener Neudorf (AT)

(21) Appl. No.: 18/566,566

(22) PCT Filed: May 30, 2022
(86) PCT No.: PCT/EP2022/064643

§ 371 Date: Dec. 1, 2023

(30) Foreign Application Priority Data
Jun. 1, 2021 (AT) A 50438/2021

(51) Int. Cl. G06F 21/64; G06K 19/06; G06Q 10/0833; H04L 9/00

(52) U.S. Cl. CPC G06F 21/64; G06K 19/06009; G06Q 10/0833; H04L 9/50

(57) ABSTRACT

The invention relates to a method for verifiable documentation of information of at least one package and/or its contents, wherein at least one unique machine-readable identifier is non-destructively detachably applied to a package which comprises at least one package material, wherein the at least one unique machine-readable identifier is associated with a unique data structure for data packets on a digitally retrievable memory, wherein the data structure associated with the unique machine-readable identifier is encrypted by means of an encryption method which prevents subsequent modification of stored information on the associated data structure.

### CROSS-REFERENCE TO RELATED APPLICATIONS

The present application is a national phase application of PCT Application No. PCT/EP2022/064643, filed May 30, 2022, entitled “METHOD FOR VERIFIABLY DOCUMENTING INFORMATION”, which claims the benefit of Austrian Patent Application No. A 50438/2021, filed Jun. 1, 2021, each of which is incorporated by reference in its entirety.

### BACKGROUND OF THE INVENTION

### 1. Field of the Invention

The invention relates to a method and system for verifiably documenting information of at least one package and/or its contents.

### 2. Description of the Related Art

It is known that packaging can have a machine-readable identifier to link digital information to the packaging. For this purpose, the identifier is usually printed directly onto the packaging material or fastened to it by means of a sticker.

A method for securing supply chain data in a blockchain is known from US 2020/0364817 A1.

A blockchain-based method for monitoring the temperature of packaging is known from US 2019/0266613 A1.

US 2019/0180291 A1 describes a platform that makes it possible to divide the production of products between different locations. The platform can connect designers, producers, freight forwarders and other companies, wherein transparency in the product supply chain is ensured by a distributed ledger or blockchain.

As a rule, the machine-readable identifier is linked to a data structure in which digital information is stored. The information stored in the data structure can also be made accessible to external persons, i.e. persons who are not directly involved in a logistics system for the product in question, so that, for example, a transport company can pass on shipping information for a product to a recipient of the product.

The disadvantage of the methods known to date is that they are only suitable to a limited extent for making credible statements about the packaging provided with the machine-readable identifiers and/or its contents. Furthermore, these are not intended and cannot be used to verify compliance with legal requirements. Information relating to packaging and/or its contents cannot be checked for accuracy and officially confirmed, as is the case with a notarized document, for example. In conventional methods, the machine-readable identifier is usually only attached to an exterior side of the packaging, for example to the packaging material, after the product has been packaged, which means that the packaging does not have a tamper-proof identification. This means that the packaging can be provided with a new machine-readable identifier at any time, wherein it is not possible to check which machine-readable identifier was attached to the packaging first. This fact in particular makes it difficult to use such methods for recycling, as the packaging to be recycled does not have any tamper-proof labeling and therefore no tamper-proof information, such as recycling information. Important information relating to the supply chain or the life cycle of the packaging can therefore no longer be retrieved and taken into account.

### SUMMARY OF THE INVENTION

The object of the invention is therefore to provide a method of the type mentioned at the beginning, with which the disadvantages mentioned can be avoided and with which information about at least one package and/or its contents can be verifiably documented over its life cycle.

This results in the advantage that tamper-proof information can be linked to the packaging, wherein each interaction with the unique machine-readable identifier of the packaging can be noted and read in a unique data structure. This provides tamper-proof documentation of information about the packaging throughout its life cycle. This means that the life cycle of the packaging, from production to disposal in a landfill and/or recycling process, is transparent and traceable. Particularly in times of increasing globalization and growing world trade, the reusability and recycling of packaging materials is becoming more and more important, especially since packaging materials pollute the environment, wherein tamper-proof information linked to the packaging is an extremely important component. One of the advantages of this is that it is possible to check how many tons of a particular type of packaging are recycled. Furthermore, retailers and consumers in particular can retrieve stored information for the packaging in question at any time and then use this information to decide whether an event has taken place since the packaging was manufactured that has adverse effects on the product contained in the packaging. Furthermore, this allows a packaging producer who produces recycled packaging materials to classify the products to be recycled according to their preferred preferences. For example, a container made of a certain plastic material that has transported chemical substances can be separated from another container that has never come into contact with harmful or hazardous chemical substances.

The invention further relates to a system for verifiably documenting information of at least one package and/or its contents.

The object of the invention is therefore also to provide a system of the type mentioned at the beginning, with which the disadvantages mentioned can be avoided and with which information on a large number of packages and/or their contents can be verifiably documented over their life cycle.

The advantages of the system correspond to the advantages of the method mentioned above.

The invention further relates to an arrangement comprising at least two semi-finished packages.

The object of the invention is therefore also to provide an arrangement with which the disadvantages mentioned can be avoided and with which the recycling of packaging can be improved.

Reference is hereby expressly made to the wording of the claims, whereby the claims are incorporated by reference into the description at this point and are deemed to be reproduced verbatim.

### BRIEF DESCRIPTION OF THE DRAWINGS

The invention is described in more detail with reference to the enclosed drawings, in which only preferred embodiments are shown by way of example. In the figures:

FIG. 1 shows a preferred embodiment of the method for documenting information of at least one package and/or its contents in schematic representation,

FIG. 2 shows a preferred embodiment of applying the unique machine-readable identifier to a package material as a principle sketch,

FIG. 3 shows a preferred embodiment of a package in schematic representation,

FIG. 4 shows a preferred arrangement of the unique data structure on a digitally retrievable memory in schematic representation,

FIG. 5 shows a preferred embodiment of an antenna without a chip in schematic representation, and

FIG. 6 shows preferred embodiments of antenna shapes in schematic view.

### DETAILED DESCRIPTION

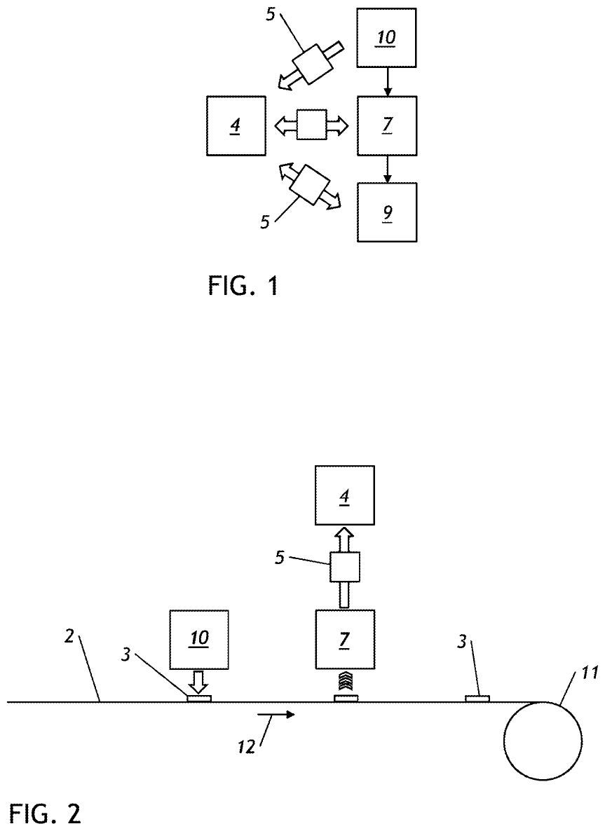

FIGS. 1 to 4 show preferred embodiments of a method for verifiable documentation of information of at least one package 1 and/or its contents, wherein at least one unique machine-readable identifier 3 is non-destructively detachably applied to a package 1 comprising at least one package material 2, wherein the at least one unique machine-readable identifier 3 is associated with a unique data structure 4 for data packets 5 on a digitally retrievable memory, wherein the data structure 4 associated with the unique machine-readable identifier 3 is encrypted by means of an encryption method which prevents subsequent modification of stored information on the associated data structure 4.

A system for verifiable documentation of information of at least one package 1 and/or its contents is further provided, wherein at least one unique machine-readable identifier 3 is non-destructively detachably applied to a plurality of packages 1 comprising at least one package material 2, further comprising a digitally retrievable memory with a unique data structure 4 for data packets 5, wherein the data structure 4 associated with the unique machine-readable identifier 3 is encrypted by means of an encryption method which prevents subsequent modification of stored information on the associated data structure 4.

An arrangement comprising at least two semi-finished packages 1 is further provided, wherein at least one unique machine-readable identifier 3 is non-destructively detachably applied to each semi-finished package 1.

This has the advantage that tamper-proof information can be linked to the package 1, with each interaction with the unique machine-readable identifier 3 of the package 1 being noted and read out in a unique data structure 4. Through this, information about the package 1 over its life cycle is documented in a tamper-proof manner. As a result, the life cycle of the package 1, from its manufacture to its disposal in a landfill and/or a recycling process 9, is transparent and traceable. Especially in times of increasing globalization and increasing world trade, the reusability and recycling of package materials 2 is becoming more and more important, especially because package materials 2 pollute the environment, wherein information linked to the package 1 in a tamper-proof manner is an extremely important component here. This results, among other things, in the advantage that it is possible to check how many tons of a particular package 1 are recycled. Furthermore, retailers and consumers in particular can retrieve stored information for the package 1 in question at any time and then use this information to decide whether an event has occurred since the production of the package 1 that has adverse effects on the product contained in the package 1. Further, this allows a package producer who manufactures recycled package materials 2 to categorize the products to be recycled according to his or her preferred preferences. For example, a container made of a certain plastic material that has carried chemical substances can be separated from another container that has never been in contact with harmful or hazardous chemical substances.

A package 1 designates a cover or an enclosure of an article, wherein the cover can completely or only partially enclose the article. The article is located within the package 1 and thus represents a content of the package 1. In this context, the package 1 protects the article from damage, environmental influences, contamination and also loss, in particular loss of quantity, such as in the case of liquids and/or gases. Further, the package 1 protects the person handling the package 1 if the package 1 contains, for example, hazardous substances and/or sharp-edged articles. Further, the package 1 may also serve to simplify handling, wherein the article or a plurality of articles may be transported more easily as a result. In this context, the article to be packaged is often called “product to be packaged” and the finished packaged product is called “package”.

The package 1 may preferably be tightly formed, wherein the escape of, in particular, liquids and/or gases from the package 1 is prevented, whereby no substantial loss of quantity of the contents occurs.

The package 1 has at least one package material 2, wherein the package material 2 is formed for packaging the contents and/or the article. The package material 2 can preferably form the outermost layer of the package 1, wherein the package material 2 at least partially, in particular completely, encloses the contents and/or the article.

In particular, the package 1 may be configured such that the package 1 can be opened without tools.

Preferably, a portion of the package material 2 may be opaque, wherein the contents of the package 1 are not revealed to an observer prior to opening the package 1.

Preferably, the package material 2 may substantially form the package 1.

Furthermore, the package material 2 may comprise a material in which passage, in particular by diffusion, through the package material 2 is prevented.

Preferably, it can be provided that the package material 2 is made of a flexible material. It is advantageous here that loose articles in particular can be connected to one another by the package material 2. Furthermore, it is also particularly advantageous that any form of article can be packaged by the in particular flexible package material 2.

Alternatively, it may be provided that the package material 2 is formed of a rigid and/or a stiff material.

The package material 2 may preferably be formed of or comprise a chemical material and/or a biological material.

In particular, the package material 2 can be formed at least from plastic and/or from metal foil and/or from paper, in particular from paper composites such as corrugated board or cardboard. In particular, the plastic is formed of PET or PETE, PE-HD or HDPE, PVC, PE-LD or LDPE, PP, PS, polycarbonate (PC), polyamide (PA), acrylonitrile butadiene styrene (ABS), polymethyl methacrylate (PMMA) and polylactide (PLA).

Preferably, it may be provided that the package material 2 is made of a renewable raw material and/or comprises a renewable raw material.

The package 1 further comprises at least one unique machine-readable identifier 3, wherein the unique machine-readable identifier 3 is non-destructively detachably applied to the package 1. The unique machine-readable identifier 3 is preferably indirectly or directly applied to the package material 2 in an application step 10. For example, an indirectly applied unique machine-readable identifier 3 may be non-destructively detachably applied to the package 1 by means of a sticker, wherein a directly applied unique machine-readable identifier 3 is directly applied to the package 1. The application step 10 thereby marks the first step in the life cycle of the package 1, as exemplified and schematically shown in FIG. 1. Furthermore, in FIG. 2, the application step 10 is exemplarily and schematically shown on a package material 2, wherein after the application step 10, the package material 2 is rolled up on a package roll 11 in a package manufacturing direction 12, which is represented by the direction of the arrow.

In particular, the application step 10 is directly subsequent to the production of the package material 2.

Preferably, it may be provided that exactly one unique machine-readable identifier 3 is non-destructively detachably applied to the package 1.

Alternatively, it may be provided that two or more unique machine-readable identifiers 3 are non-destructively detachably applied to the package 1.

Preferably, the at least one package material 2 can be rolled onto the package roll 11 after the unique machine-readable identifier 3 has been applied. In particular, the package roll 11 may also be referred to as roll stock. In particular, the roll stock may be provided for packaging articles or contents. When packaging articles or contents, the package material 2 is unwound from the package roll 11 or the roll stock and wrapped around the article to be packaged or later contents of the package 1. Preferably, only a certain part of the package roll 11 is used for packaging the article or later contents of the package 1, which certain part results from the geometric dimensions of the article to be packaged or later contents of the package 1.

Preferably, a plurality of unique machine-readable identifiers 3 may be spaced apart from each other on the package material 2 of the rolled-up package roll 11. Preferably, it may be provided that the unique machine-readable identifiers 3 are spaced apart from each other on the rolled-up package roll 11. In particular, it may be provided that the unique machine-readable identifiers 3 have an equal spacing from one another on the rolled-up package roll 11.

In particular, it may be provided that the unique machine-readable identifiers 3 on the rolled-up package roll 11 have a different spacing from one another. This has the advantage that a company wishing to package articles can indicate to the manufacturer of the package roll 11 the dimensions of the articles to be packaged and the manufacturer can adjust the spacing of the unique machine-readable identifiers 3 on the package roll 11 based on the articles to be packaged by the company. This further provides the advantage that the company can decide how many unique machine-readable identifiers 3 are applied to the package 1 for the subsequent packaged article or content.

In particular, the unique machine-readable identifier 3 is non-destructively detachably applied to the package material 2 during the manufacture of the package 1. The package 1 is designed in such a way that a read-out of the machine-readable identifier 3 is made possible by means of a readout device.

The unique machine-readable identifier 3 may preferably be and/or comprise a visual code, in particular a barcode and/or a pattern, and/or a chip, in particular an RFID chip. In particular, the chip may also be referred to as an electronic tag.

Preferably, the readout device can be designed to read out the visual code and/or the chip. Preferably, the readout device can be designed for electronic data processing. Preferably, the electronic data processing comprises the electronic acquisition, processing, transport and output and reproduction of data. Preferably, the electronic data processing is performed on a computer by means of software-operated processes.

Preferably, the readout device can be a data acquisition device. Preferably, the readout device can use data exchange via WLAN, GSM network or the like. Preferably, the readout device can establish a connection to the data structure 4 associated with the unique machine-readable identifier 3 by reading out the unique machine-readable identifier 3. The connection to the data structure 4 associated with the unique machine-readable identifier 3 can preferably be established by means of an interface, in particular by means of a radio interface. In this context, the readout device can preferably use the interface to establish a connection to a server on which the associated data structure 4 is stored and transmit data to this server. In this context, the radio interface can preferably also be referred to as an air interface, wherein radio interface means in particular the transmission of data by means of electromagnetic waves. Preferably, the readout device can also transmit data to a computer which is at least indirectly connected to the server on which the associated data structure 4 is stored, wherein this computer creates a data packet 5 from the transmitted data of the readout device and adds it to the associated data structure 4.

Alternatively, the readout device can create a data packet 5 itself and add the data packet 5 to the associated data structure 4.

Preferably, any device that can read the unique machine-readable identifier 3 can create and/or add a data packet 5 to the associated data structure 4.

Further, it may preferably be provided that by establishing the connection between the unique machine-readable identifier 3 and the associated data structure 4, a data packet 5 is added to the associated data structure 4. Preferably, this data packet 5 added to the associated data structure 4 by reading out the unique machine-readable identifier 3 may comprise the time of reading out the unique machine-readable identifier 3 and/or information about the readout device and/or the location of reading out the unique identifier 3 with the readout device. Since various readout devices capable of reading out a unique machine-readable identifier 3 are known to a person skilled in the art, a further embodiment of how such a reading out of machine-readable identifiers 3 can be performed is omitted. Only by way of example, the reading out by means of a cell phone, in particular a smartphone, is mentioned at this point, wherein in this case, for example, the camera or other sensors installed in the cell phone can read out the unique machine-readable identifier 3, can establish a connection with the associated data structure 4 of the unique machine-readable identifier 3 and can add a data packet 5 to the associated data structure 4.

The barcode may further preferably be a strip code and/or a barcode. In particular, the unique machine-readable identifier 3 may comprise an optoelectronic readable font, wherein the optoelectronic font may comprise parallel bars and gaps of different widths, wherein the optoelectronic font may be read and evaluated by an electrical reader, in particular a CCD scanner and/or a reading pen and/or a cell phone scanner and/or a laser scanner.

Furthermore, the visual code may preferably comprise a unique pattern. The unique pattern may particularly preferably be arranged on at least one region of the package 1, in particular on the package material 2. In particular, the unique pattern may comprise differently shaped lines, resulting in the unique pattern. The visual code may preferably also comprise an image, such as a painting or a print. The visual code may particularly preferably identify the location of the chip.

Preferably, the visual code is a dot code, in particular a dot code. Preferably, the visual code is a matrix code, in particular a QR code or a data matrix code. Alternatively, the visual code can be any other code which can be read visually and which allows a unique machine-readable identification.

The visual code can preferably be printed directly on the package material 2.

The chip can preferably be a transponder, in particular an RFID chip. In particular, the chip can comprise any technical component on which a unique identification can be stored, for example a hard disk or a magnetic card. This gives the advantage that the chip can be individualized and need not be visible for reading. For example, a package 1 can have a unique machine-readable identifier 3 without being visible to persons who have no information about it.

Preferably, if the chip is an RFID chip, an RFID transponder may include an antenna, an analog circuit for receiving and transmitting (transceiver), a digital circuit, and a permanent memory. In particular, the digital circuit may be a microcontroller. Preferably, the RFID chip comprises a memory that can be written to at least once. Preferably, the unique machine-readable identifier 3 is stored on the at least write-once memory. Preferably, the at least write-once memory may also store other data deemed relevant by the manufacturer of the package material 2.

Preferably, the at least write-once memory may comprise a memory size of at least 50 bits, more preferably at least 75 bits, in particular at least 100 bits.

Preferably, the minimum write-once memory can comprise a memory size of at most 250 bits, particularly preferably at most 200 bits, especially at most 150 bits.

Preferably, the RFID chip can be read by the readout device, wherein a high-frequency electromagnetic alternating field is preferably generated by the readout device for this purpose and the RFID chip is exposed to this high-frequency electromagnetic alternating field. Preferably, the RFID chip can be designed without an additional energy supply. If the RFID chip is designed without an additional power supply, the radio frequency energy absorbed by the antenna of the RFID chip during the communication process with the readout device can preferably serve as the power supply. Preferably, the RFID chip activated by the high-frequency electromagnetic alternating field transmits data, in particular the stored unique machine-readable identifier 3, to the readout device by field weakening.

Alternatively, the power supply of the RFID chip can preferably be provided by an additional power supply, in particular a battery.

Preferably, it may be provided that the package 1 comprises the chip and/or the visual code.

The unique machine-readable identifier 3 is assigned a unique data structure 4 on a digitally retrievable memory. In this context, the associated data structure 4 comprises any kind of structure in which data, respectively data packets 5, can be stored in a predetermined manner, wherein the data packets 5 are preferably arranged and linked in a certain way. In this context, the term data structure 4 preferably includes data sets, data fields, concatenated lists, queues, graphs, trees, heaps and hash tables. The associated data structure 4 is the unique data structure 4 associated with the at least one unique machine-readable identifier 3.

Preferably, the at least one unique machine-readable identifier 3 is assigned to the unique data structure 4 at the latest prior to packaging of a subsequent item contained in the package 1.

Preferably, the unique data structure 4 is created by means of a data structure creation unit. For this purpose, the data structure creation unit can preferably be connected to a digitally retrievable memory, in particular via an interface. Preferably, the data structure creation unit is designed to create unique data structures 4 on the digitally retrievable memory. The creation of the unique data structures 4 is preferably performed with a computer by means of software-operated processes.

Preferably, the unique machine-readable identifier 3 can be assigned the unique data structure 4 by means of an assignment unit. Preferably, the assignment of the unique machine-readable identifier 3 to the unique data structure 4 is performed with a computer using software-driven processes. Preferably, the assignment unit may comprise software that assigns the at least one unique machine-readable identifier 3 to the unique data structure 4 by means of the software. Preferably, the software may be stored on the computer for this purpose. Preferably, the assignment unit can be connected to the readout device for this purpose, in particular via an interface.

Preferably, a production plant that manufactures the at least one package 1 and/or packages an article in the package 1 may comprise the data structure creation unit and/or the assignment unit. Preferably, the production plant that produces the at least one package 1 and/or packages the article in the package 1 may be connected to the computer that creates the unique data structure 4 and/or assigns it to the unique machine-readable identifier 3. For this purpose, the production plant may comprise the readout device for the unique machine-readable identifier 3.

The term data comprises any type of information added to the data structure 4 as a data packet 5, wherein the added information may in particular comprise characters, symbols, facts, location information, time information, observations, measurements, numerical values and/or personal information. In this context, the data packets 5 added to the associated data structure 4 preferably serve the purpose of a processing, in particular by a computer. Data packets 5 thus comprise data, wherein the data may comprise one or more types of information.

Preferably, it may be provided that the data structure 4 comprises at least the time of the non-destructively detachable application of the at least one unique machine-readable identifier 3. In particular, the time of the non-destructively detachable application of the at least one unique machine-readable identifier 3 at the time of the application can be stored as a data packet 5 in the data structure 4. This results in the advantage that the age of the package 1 can be verified, wherein, for example, the age of a package which is purchased from a retailer can be verified on the basis of the manufacturing data and, in particular, officially authenticated after the time of the non-destructively detachable application of the at least one unique machine-readable identifier 3 is stored in the data structure 4 in a tamper-proof manner. Particularly in the case of materials which must not exceed a predetermined age, for example for a manufacturer's warranty, the age of this material can be verified essentially by means of the age of the package 1. Furthermore, by means of the exact age of a material, its resistance to, for example, environmental influences and/or storage conditions can preferably be examined.

The digitally retrievable storage may preferably be a server.

The associated data structure 4 is located on the digitally retrievable memory, wherein the digitally retrievable memory may include more than the one associated data structure 4, as can also be seen in FIG. 4. In FIG. 4, the dotted lines represent two other unique data structures with data packets associated with other unique machine-readable identifiers.

Alternatively, it may be provided that the digitally retrievable memory is located at an external company, wherein the external company is not the manufacturer of the package 1.

The associated data structure 4 can preferably be encrypted using different encryption methods, wherein the encryption method must be designed in such a way that subsequent modification of stored information on the associated data structure 4 is prevented.

Preferably, a digital twin is created on the digitally retrievable memory for the at least one package 1. It may preferably be provided that a digital twin is created on the digitally retrievable memory during the non-destructively detachable application of the unique machine-readable identifier 3. The digital twin may in particular also be referred to as a “digital twin”. In this context, the digital twin reflects the article or the contents of the package 1 from the real world in the digital world. Preferably, the digital twin is created by a computer. This results in the advantage that the digital twin allows the life cycle of the at least one package 1 to be used even after the recycling of the at least one package 1, for example for statistical purposes, whereby the recycling of package 1 can be improved.

Alternatively, the digital twin can be created when packaging the content.

Preferably, it may be provided that the unique machine-readable identifier 3 is applied in a semi-finished state of the package 1. The package 1 in the semi-finished state may also be referred to as a semi-finished package 1. In this context, a semi-finished package 1 refers to a semi-finished product, which is also preferably referred to as a blank, wherein the term semi-finished package 1 and/or semi-finished product is known to a person skilled in the art in the field of packages 1. Preferably, the unique machine-readable identifier 3 is applied to the package material 2 during production of the semi-finished package 1. This results in the advantage that the unique machine-readable identifier 3 can be applied to the package material 2 directly during the production of the package 1, in particular during the production of the package material 2, and not only during the package of the contents of the package 1. In this case, the package 1 preferably does not yet have any contents.

Preferably, the at least one unique machine-readable identifier 3 is assigned to the unique data structure 4 between the time of the non-destructively detachable application of the unique machine-readable identifier 3 to the semi-finished package 1, in particular to the package material 2, and the delivery of the semi-finished package 1. This results in the advantage that the manufacturer of the semi-finished product or of the semi-finished package 1 assigns the at least one unique machine-readable identifier, whereby the origin of the package 1 or of the package material 2 can be documented in a tamper-proof manner.

Preferably, a first data packet 5 may be added to the associated data structure 4 prior to delivery of the semi-finished package 1.

Preferably, the first data packet 5 added to the associated data structure 4 may be added by the manufacturer of the semi-finished package 1.

In particular, it may be provided that the semi-finished state of the package 1 is a film having a plurality of sections, wherein a unique machine-readable identifier 3 is non-destructively detachably applied to each section, and the time of non-destructively detachably application of the unique machine-readable identifier 3 to the package 1 is added to the data structure 4. Preferably, after the unique machine-readable identifier 3 is applied to the respective sections, the film having the plurality of sections can be rolled up onto a package roll 11. When packaging a content or an article, in particular, a package unit is taken from the package roll 11 which has at least one unique machine-readable identifier and with which the content or the article is packaged.

Preferably, it may be provided that the unique machine-readable identifier 3 is at least partially printed on the package material 2. A unique machine-readable identifier 3 printed on the package material 2 is, for example, a unique machine-readable identifier 3 applied directly to the package material 2 in an application step 10. This results in the advantage that the package 1 can be quickly and easily marked with a unique machine-readable identifier 3.

In particular, an antenna or a battery may be printed on the package material 2.

In particular, the antenna can be printed with an ink comprising silver and/or copper as the conductive material.

In particular, the antenna can be a fractal antenna. A fractal antenna is an antenna that achieves broadband transmission and reception quality by using fractal structures. Preferably, the fractal antenna comprises Koch curves or Sierpinski triangles.

In particular, the chip may include the antenna or the battery.

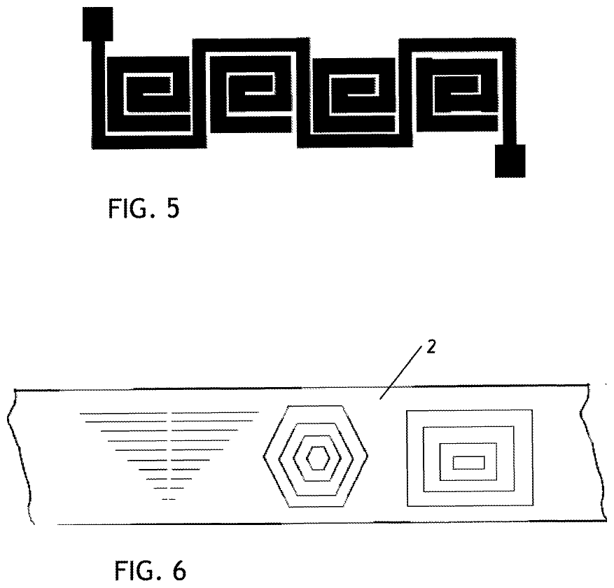

Alternatively, the antenna can be designed without a chip. FIG. 5 shows a preferred embodiment of an antenna that is designed without a chip.

Preferably, the at least one unique machine-readable identifier 3 can be at least partially applied to the package material 2 by means of a laser. Preferably, the laser may be a gas laser or a dye laser or a solid-state laser. This results in particular in the advantage that the unique machine-readable identifier 3 can be applied to the package material 2 quickly and precisely, as well as permanently and tamper-proof.

FIG. 6 shows preferred antenna shapes, with the antenna shapes comprising a preferred bit depth of up to 35 bits. The preferred antenna shapes shown in FIG. 6 can in particular be printed onto the package material 2 down to a size smaller than 10 mm.

Alternatively, it can be provided that the unique machine-readable identifier 3 is embedded in the package material 2, wherein the package material 2 surrounds the unique machine-readable identifier 3, in particular in a form-fitting manner, wherein the unique machine-readable identifier 3 is preferably held in a stationary manner by the package material 2. This results in the advantage that the unique machine-readable identifier 3 is protected from damage.

In particular, the unique machine-readable identifier 3 can be embedded between two films, wherein the films are preferably formed of plastic. In this context, the unique machine-readable identifier 3 can preferably be embedded during the production of a plastic package, in particular during film extrusion.

Alternatively, the machine-readable identifier 3 can preferably be embedded during papermaking. In this case, the machine-readable identifier 3 can preferably be added to the fiber pulp, wherein the machine-readable identifier 3 is embedded in the finished paper in a form-fitting manner after drying of the fiber pulp.

Preferably, it can be provided that the unique machine-readable identifier 3 is read out via radio. This has the advantage that the package 1 can be read out without contact and without visual contact, wherein contaminated packages in particular can be read out easily and quickly.

Radio may also be referred to as radio technology and preferably includes a method of transmitting signals wirelessly using modulated electromagnetic waves in the radio frequency range. In this regard, a read-out via radio may preferably comprise the use of the readout device. Preferably, NFC can be used to establish a data exchange between the unique machine-readable identifier 3, in particular an RFID chip, and the readout device, wherein the data structure 4 is read out. In this context, the terms RFID and NFC denote “radio frequency identification” and “near field communication”. Preferably, the readout device can comprise any electrical device that enables the data structure 4 to be read out via radio.

In particular, the readout device may be built into smart devices, such as a smart refrigerator.

In particular, an invoice can be automatically generated by reading out the unique identifier 3.

Preferably, the unique machine-readable identifier 3 can be used for smart contracts.

In particular, reading out the unique machine-readable identifier 3 can initiate an automatic bank transfer. This has the advantage that reading out the unique machine-readable identifier 3 can also be used to pay for a product. For example, an ordered product can be paid upon receipt of the delivery by the readout device of the transport service provider.

Particularly preferably, it can be provided that the encryption method comprises a distributed ledger method, in particular a blockchain method 6. This results in the advantage that data packets 5 added later to the data structure 4 build on previous data packets 5 and confirm them with regard to their correctness, resulting in a seamless transition of the added data packets 5. Thus, the data packets 5 can be stored on the data structure 4 in a tamper-proof manner, wherein a trustworthy data structure 4 can be created, which is similar to an officially certified document in terms of trustworthiness. In particular in the food sector and/or in the recycling industry, such data structures 4 can be useful if they have been filled with relevant information. Thus, for example, it is possible to verify which contents have been transported in the package 1, from which package material 2 the package 1 has been manufactured, how old the package 1 is, and if storage information has been stored in the data structure 4, also under which conditions the package 1 has been stored. In this way, for example, a conclusion can also be drawn about the storage of the contents of the package 1.

In particular, the associated data structure 4 may comprise a chain of data packets 5, wherein each data packet 5 in the chain is concatenated with each other, in particular by means of cryptographic methods, as can be seen in FIG. 4. Such a structure of data packets 5 is in particular called blockchain method 6, wherein each data packet 5 represents a block in this case. Preferably, in blockchain method 6, blocks added later to the chain build on earlier blocks of the chain. This results in the advantage that, in the event of a desired manipulation of an earlier block in the chain, all blocks added later to the chain would also have to be manipulated so that the manipulation would not be noticed, as a result of which the blockchain method 6 is considered to be highly tamper-proof.

Preferably, it can be provided that the encryption method uses key pairs for encrypting and decrypting the data packets 5, with the machine-readable identifier 3 containing a public key. This has the advantage that the data packets 5 added to and/or read out from the data structure 4 can be controlled, in particular it can be ensured that information cannot be added to the data structure 4 by any person.

In particular, it may be provided that the data packets 5 are encrypted with the public key.

In particular, it may be provided that the data packets 5 are decrypted with the private key.

In particular, it can be provided that only the private key can be used to read the data packets 5 from the data structure 4.

It may preferably be provided that the private key is stored with an independent body. The independent body may in particular be an official authority or an external company, with the external company not being the manufacturer of the package 1. This results in the advantage that the decryption of the data packets 5 cannot be carried out by any person, wherein the security of the private keys can be guaranteed. Furthermore, this can advantageously increase the credibility of the information added to the data structure 4 by the package manufacturer for a potential buyer.

Preferably, the unique machine-readable identifier 3 is read out with the readout device, with the further data packet 5 being transmitted via a data network of the associated data structure 4. In this context, the data network may be, for example, the Internet or a mobile data network.

Furthermore, it can preferably be provided that each time the unique machine-readable identifier 3 is read out, a further data packet 5 is added to the associated data structure 4. This results in the advantage that each contact or each read-out process of the package 1 can be documented, wherein the life cycle of the package 1 can be traced. For example, when the package 1 is sold at a supermarket checkout, the unique machine-readable identifier 3 can be read by a checkout scanner, adding another data packet 5 to the data structure 4, allowing the sale of the package 1 to be verified later.

In particular, it may be provided that the unique machine-readable identifier 3 is read out by a readout device of a smart appliance at predetermined intervals. This results in the advantage that, for example, a smart refrigerator which is to comprise a predefined number of foodstuffs can check this number by means of the readout device and the unique machine-readable identifier 3, so that, in particular, if a particular type of foodstuff is missing, wherein type means, for example, milk, yogurt, etc., this can be retrieved at the smart refrigerator. Furthermore, this results in the advantage that a warning can be displayed in particular on a smart refrigerator if a foodstuff has exceeded the best-before date and is therefore no longer suitable for consumption without restrictions. Furthermore, it is advantageous that when a product is recalled, the information about the recall action can be displayed on the smart device.

In particular, it can be provided that information regarding the readout device is added to the data packet 5. In this way, it is advantageously possible to verify which readout devices have read out the data structure 4, and in particular it is possible to verify which readout device, such as in the food sector which supermarket checkout, has read out the unique machine-readable identifier 3 of the package 1 during its lifetime.

Furthermore, it may be particularly preferably provided that a further data packet 5 is added to the associated data structure 4 only when the unique machine-readable identifier 3 is read out. This has the advantage that information can only be added to the data structure 4 by persons who read out the unique machine-readable identifier 3, thus preventing subsequent modification of the data packets 5 on the data structure 4. Thus, for example, information that has been added to the data structure 4 by someone in the course of the life cycle of the package 1 cannot be subsequently changed by that person if the package 1 is no longer in his possession after a past time. In particular, this can increase the security of the information contained in the data structure 4.

In particular, it may be provided that another data packet 5 is added to the associated data structure 4 only when the public key is read out.

Furthermore, it may preferably be provided that the step of non-destructively detachably applying the unique machine-readable identifier 3 to the package 1 is immediately followed by the first time a data packet 5 of the associated data structure 4 is added. In particular, the first data packet 5 added to the data structure 4 may comprise the time of application of the unique machine-readable identifier 3 to the package 1. In particular, the first data packet 5 added to the data structure 4 may comprise the time of application the unique machine-readable identifier 3 to the package 1. In particular, the first data packet 5 added to the data structure 4 may identify the production plant of the package 1. This results in the advantage that the first data packet 5 added to the data structure 4 is preferably added by the package manufacturer, wherein the correctness of the first added data packet 5 is guaranteed. In particular in the blockchain method, wherein later data packets 5 added to the data structure 4 are based on earlier data packets 5, it can be ensured that further data packets 5 added to the data structure 4 are at least not based on an incorrect first data packet 5.

In particular, it may be provided that the first data packet 5 added to the data structure 4 is added at the latest prior to the packaging of a subsequent item contained in the package 1.

Preferably, the first data packet 5 added to the data structure 4 may comprise at least one value about the energy required to produce the package 1 and/or its contents. This has the advantage that the CO₂ footprint of the package can be verified, whereby improvements in the energy balance of package can be achieved.

Preferably, the first data packet 5 added to the data structure 4 may comprise information of at least one previous unique machine-readable identifier 3, wherein the previous unique machine-readable identifier 3 was applied to a source product of the package 1. In particular, the previous unique machine-readable identifier 3 may have been applied to a raw material, wherein the raw material was, for example, a living being, such as a pig, a cow or a poultry, or a tree or a plant. This gives the advantage that source products which the package 1 comprises, is necessary for the manufacture of the package 1, or which it contains, can be traced back to its origins. For example, in a package comprising a paper package material where wood is the source product, information about the logs needed for the production of the package material can thereby be added to the data package 5, especially if the logs have been provided with a unique machine-readable identifier directly after their planting. This can, for example, add information about the rearing and/or the location of the source product to the data package 5. Furthermore, this allows, for example, a consumer of a pork cutlet who buys it in a grocery store to obtain information about the rearing of the pig, as well as about its origin and slaughter, thereby guaranteeing the origin of the contents of the package and making it transparent to the consumer. For example, it can be checked whether a product that advertises itself as “made in Austria” on its package really is “made in Austria”.

Furthermore, it may be particularly preferably provided that at least one sensor 7 for reading out the unique machine-readable identifier 3 comprises at least one unique sensor security information and that during the reading out of the unique machine-readable identifier 3 with the at least one sensor 7 the at least one unique sensor security information is added to the further data packet 5. This results in the advantage that the sensor 7 which reads out the unique machine-readable identifier 3 is marked in the data structure 4, whereby the sensor 7 can be uniquely identified.

Preferably, the readout device may comprise the at least one sensor 7 having the at least one unique sensor security information.

Preferably, the sensor security information can identify a production plant in the data structure 4. In this context, the term production plant includes any technical plant processing the package 1. This results in the advantage that the production plant becomes unique, wherein the production plant can be precisely assigned even in the case of several identical production plants in a factory, wherein this can be verified during the entire life cycle of the package 1. In particular, production defects in a package 1 caused by a production plant can be clearly assigned to the production plant that caused them. Furthermore, it can be ensured that the package 1 was actually processed by the specified production plant.

In particular, it may be provided that the first data packet 5 added to the data structure 4 comprises the sensor security information.

Furthermore, it can preferably be provided that at least one data packet 5 comprising at least one composition information of the package material 2 is added to the associated data structure 4. This has the advantage that it is possible to check which composition the package material 2 contains, wherein in particular a defective ingredient of the package material 2 can be easily detected and sorted out even years later. Furthermore, this advantageously has the effect that the recycling of package 1 can be improved, since a person interacting with the package 1 can set the correct recycling step for the package 1 on the basis of the at least one composition information of the package material. Furthermore, it can be achieved that from a purely statistical evaluation of certain packages 1 to an individual tracking of individual packages 1, the actual recycling rate can be improved. By allowing a person at the end of the life cycle of the package 1 to easily and quickly identify how to properly recycle the package 1 by reading the associated data structure 4 and retrieving the at least one composition information, an environment can be created with which the recycling of package 1 can be generally improved.

Preferably, in the semi-finished state of the package 1, the data packet 5 comprising the at least one composition information of the package material 2 may be added to the associated data structure 4. In particular, the composition information of the package material 2 may be provided by the manufacturer of the package material 2.

In particular, it may be provided that the associated data structure 4 is linked to a further data structure. This can be preferably provided in particular if the package 1 comprises more than one package material 2. In this way, it is particularly advantageous to be able to check which components, such as PE or PVC in the case of plastics, the package 1 is composed of if it is formed from more than one package material 2, such as hybrid package, and if the composition information of the individual components of the package has been added to the individual data structures. This also advantageously allows the amount of the components of the package 1 to be calculated as a percentage.

In particular, the composition information may include chemical information and/or biological information.

In particular, the composition information may include at least one additional component information. For example, plasticizers, fillers and binders may be included in plastics as additional components.

Preferably, the additional component can be essential for the properties, in particular for the material properties, of the package material 2. Material properties are understood to include, among other things, the mechanical properties, such as elastic or plastic behavior, electrical and/or magnetic properties, but also chemical properties.

Furthermore, it may preferably be provided that at least one data packet 5 comprising at least one material property of the package material 2 is added to the associated data structure 4. Preferably, the material properties may comprise the mechanical properties, such as for example the strength, the hardness or the stiffness, the thermal properties, such as for example the coefficient of expansion, the temperature and heat deflection temperature, the melting temperature, the electrical properties and the optical properties. Preferably, the at least one data package 5 may also include other material properties not enumerated above if the manufacturer of the package 1 deems such other material properties useful.

Preferably, the first data packet 5 added to the associated data structure 4 may comprise at least one material property of the package material 2.

In particular, it may be provided that the first data packet 5 added to the data structure 4 comprises the composition information of the package material 2.

Particularly preferably, it may be provided that the composition information comprises at least one main component of the package 1. In this regard, it is known to the person skilled in the field of package 1 what a main component of a package 1 may comprise. For example, the main component of a package 1 which is formed only of polyethylene is ethylene.

Preferably, it may be provided that a data package 5 comprising at least one ingredient information of at least one content of the package 1 is added to the unique data structure 4. This has the advantage that the contents of the package 1 become transparent and thus accessible to a user without an analysis procedure. As a result, it is possible to verify, in particular without opening the package 1, which contents the package 1 contains. In particular, if a label of the package 1 can no longer be clearly identified, the contents of the package 1 can be verified in this way. Advantageously, a damaged content of the package 1, which the package 1 has transported in the course of its life and which has accumulated, for example, in the package material 2, can be traced even years later. This has the further advantage that a consumer of a foodstuff can verify the ingredients of the foodstuff, wherein incompatibilities or allergic reactions can be prevented, wherein in particular nutritional information about the contents of the package 1 can also be retrieved for a customer.

Furthermore, it can preferably be provided that at least one data package 5 comprising at least one recycling information for the package material 2 and/or for the contents of the package 1 is added to the associated data structure 4. This results in the advantage that a targeted recycling of the package 1 can be achieved, because the package material 2 can be divided into different categories or into substance classes and these can be recycled in a targeted manner and separately from one another. This results in the further advantage that persons who read the unique machine-readable identifier 3 can retrieve the recycling information, so that the package 1 can also be disposed of correctly by these persons. In this way, in particular, uncertainties of persons in the assignment of the package 1 to the individual waste containers, such as to residual waste, plastic or to waste paper, can be avoided. For example, by reading out the unique machine-readable identifier 3, it can be determined that a pizza box, as long as it was not intended for storing a pizza, belongs in the waste paper container, whereas a pizza box with leftovers after storing a pizza belongs in the residual waste. Furthermore, it can be achieved that from a purely statistical evaluation of certain packages 1 to an individual tracking of individual packages 1, the actual recycling rate can be improved. By enabling a person at the end of the life cycle of the package 1 to easily and quickly identify how to properly recycle the package 1 by reading the associated data structure 4 and retrieving the at least one piece of recycling information for the package material 2, an environment can be created with which the recycling of package 1 can generally be improved.

In particular, the recycling information for the package material 2 may be provided by the manufacturer of the package material 2.

In particular, it may be provided that the first data packet 5 added to the data structure 4 comprises the at least one recycling information for the package material 2 and/or for the contents of the package 1.

In particular, it may be provided that at least one data packet 5 comprising the recycling content of the package 1 is added to the associated data structure 4. This has the advantage that a consumer can check the recycling proportion of the package 1, whereby package with a high recycling proportion in particular can be prioritized by the customer.

In particular, it can be provided that the package material 2 is provided with a certificate, wherein the composition of the package material 2 can be guaranteed because its origin was verifiable for the production. Furthermore, packages 1 which have come into contact with a chemical substance during their life cycle and have thus been contaminated can be sorted out from packages 1 which have not been contaminated by these chemical substances.

In particular, it may be provided that the recycling information contains at least one hazard note if the package material 2 and/or the contents of the package 1 are classified as a hazard or as a hazardous substance at the time the unique machine-readable identifier 3 is read out.

Furthermore, it may preferably be provided that the unique machine-readable identifier 3 is read out during a recycling process 9 of the package 1. This has the advantage that the package 1 is correctly recycled at the end of its life cycle. Further, this can provide statistics on how many packages 1 of a particular type of package are recycled, thereby enabling improvements in recycling management. This also has the advantage that conclusions can be drawn about the recycling behavior of customers.

Preferably, the method may include identifiable users, wherein the actions of the identifiable users may be recorded and linked to the data structure 4. In particular, identifiable users are consumers or customers who, for example, purchase a package 1 in a grocery store, or companies that manufacture a package material 2 or package 1 or package an article therein. In particular, any person who comes into contact with the package 1 may be an identifiable user.

In particular, when the package 1 is purchased, the identifiable user may be associated with the package 1.

In particular, the identifiable users may include user accounts, wherein the user accounts record and administer the actions of the identifiable users with the package 1.

Preferably, the identifiable users, in particular the user accounts, may be associated with a reward system, wherein the reward system may in particular comprise digital assets. Preferably, digital assets can be tokens or “utility tokens”. This results in the advantage that, for example, persons who properly dispose of package can be confirmed or rewarded in their disposal behavior by the reward system. For example, a person who has properly disposed of a predetermined number of packages can thereby receive a bonus for this behavior, wherein the bonus can comprise in particular a voucher or a special offer. This further results in the advantage that legal requirements, in particular for companies, can be checked quickly and easily, wherein a company which, for example, does not meet a prescribed legal minimum recycling rate can be given incentives which help in meeting these requirements. In particular, by linking to the tamper-proof data structure 4, automated processing with the reward system can be achieved, wherein the reward system, in particular the data stored in the reward system, is also tamper-proof due to the linking to the data structure 4.

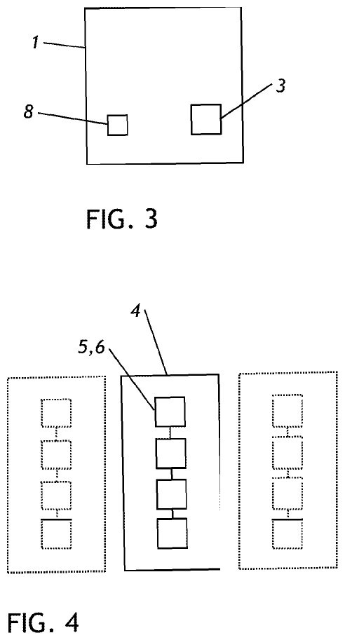

Furthermore, it may preferably be provided that the package 1 comprises at least one package sensor 8, wherein package sensor information is added to the further data packet 5 when the unique machine-readable identifier 3 is read out. This results in the advantage that the package 1 can be monitored in its life cycle by means of a package sensor 8, wherein the monitoring can also comprise only a certain lifetime of the package 1. In particular, FIG. 3 shows a package 1 with a unique machine-readable identifier 3 and a package sensor 8.

Preferably, the package sensor 8 may be a temperature sensor and/or an acceleration sensor.

Preferably, it may be provided that the package sensor 8 is coupled to the unique machine-readable identifier 3, in particular to the chip, via an interface, in particular via a radio interface.

In particular, it may be provided that the date of an event of the temperature sensor and/or of the acceleration sensor is added to the further data packet 5. This has the advantage that it can be checked whether damaging events have occurred for the package 1 and/or for the contents of the package 1. For example, in the case of contents of the package 1 from the food sector, the best-before date of the contents can be extended because it can be verified whether a predefined temperature range has been fallen below or exceeded. Compliance with a predefined temperature range is also of particular importance, for example, in the case of pharmaceuticals, in particular vaccines. Furthermore, it is also possible, for example, to check for blows and/or drops that have been inflicted on the package 1. This also has the advantage that, for example, a transport company can prove to its insurance company that its transported goods have been transported safely and gently.

Preferably, it may be provided that the package sensor 8 is applied to the package material 2.

In particular, the package sensor 8 may be at least partially printed on the package material 2.

Alternatively, the package sensor 8 may be embedded in the package material 2.

Preferably, it may be provided that the at least two semi-finished packages 1 are contiguous. This results in the advantage that further handling with the semi-finished packages 1 is significantly facilitated. For example, this can facilitate the transport of the semi-finished packages 1 because the semi-finished packages 1 can be transported in bundles or rolled up on package rolls 11. Furthermore, this also allows articles to be packaged more quickly by means of a machine in an automated process. As a result, the contiguous semi-finished packages 1 can, for example, be clamped in the machine, wherein the machine packs articles, which each belong in a package 1, with a semi-finished package 1.

Preferably, the at least two contiguous semi-finished packages 1, in particular a plurality of contiguous semi-finished packages 1, may form a strip. Preferably, the at least two contiguous semi-finished packages 1 are formed on the strip such that each semi-finished package 1 of the at least two contiguous semi-finished packages 1 forms a package 1 for a subsequent article located in the package 1.

Preferably, it may be provided that exactly one unique machine-readable identifier 3 is non-destructively detachably applied to each semi-finished package 1.

Preferably, it may be provided that the at least two contiguous semi-finished packages 1 are rolled up on the package roll 11.

Preferably, the present invention can be divided into three levels. Preferably, a first level may be referred to as a physical level. The first level preferably comprises the activities of the at least one package 1 having the at least one unique machine-readable identifier 3. A second level may preferably be referred to as the digital level. The second level preferably comprises the activities of the digital twin, which digital twin is generated to the at least one package 1. A third level may preferably be referred to as an ecosystem level. The third level preferably comprises the activities of the identifiable users.

The following are principles for understanding and interpreting subject matter disclosure.

Features are usually introduced with an indefinite article “a, an”. Therefore, unless the context indicates otherwise, “a, an” is not to be understood as a numeral word.

The connective word “or” is to be interpreted as inclusive and not exclusive. Unless the context indicates otherwise, “A or B” also includes “A and B”, where “A” and “B” represent arbitrary features.

By means of an ordering number word, for example “first”, “second” or “third”, in particular a feature X or an article Y is distinguished in several embodiments, unless otherwise defined by the disclosure of the invention. In particular, a feature X or subject matter Y with an ordering numeral in a claim does not mean that a design of the invention covered by that claim must have a further feature X or a further subject matter Y, respectively.

In the case of value ranges, the end points are included unless the context indicates otherwise.

1-15. (canceled)

16. A method for verifiably documenting information of at least one package, comprising:
detachably attaching, non-destructively, at least one unique machine-readable identifier to a package comprising at least one packaging material;
associating the at least one unique machine-readable identifier with a unique data structure for data packages on a digitally retrievable storage;
encrypting the data structure associated with the unique machine-readable identifier by an encryption method which prevents subsequent alteration of stored information on the associated data structure; and
adding the associated data structure to at least one data package, the at least one data package comprising at least one of:
at least one piece of composition information for the packaging material; and
at least one piece of recycling information for the packaging material.

17. The method according to claim 16, wherein the unique machine-readable identifier is applied in a semi-finished state of the package.

18. The method according to claim 16, wherein the unique machine-readable identifier is at least partially printed on the packaging material.

19. The method according to claim 16, wherein the unique machine-readable identifier is read out via radio.

20. The method according to claim 16, wherein the encryption method comprises a distributed ledger method.

21. The method according to claim 20, wherein the distributed ledger method comprise a blockchain method.

22. The method according to claim 16, wherein:
the encryption method uses key pairs for encrypting and decrypting the data packages; and
the machine-readable identifier contains a public key.

23. The method according to claim 16, further comprising adding a further data package to the associated data structure each time the unique machine-readable identifier is read.

24. The method according to claim 16, further comprising adding a further data package to the associated data structure only when the unique machine-readable identifier is read out.

25. The method according to claim 16, wherein the step of non-destructively detachably attaching the at least one unique machine-readable identifier to the package is immediately followed for a first time by adding the at least one data package to the associated data structure.

26. The method according to claim 16, wherein the unique machine-readable identifier is read out during a recycling operation of the package.

27. A system for verifiably documenting information on at least one package, comprising:
an attaching arrangement for detachably attaching, non-destructively, at least one unique machine-readable identifier to a package comprising at least one packaging material;
an associating arrangement for associating the at least one unique machine-readable identifier with a unique data structure for data packages on a digitally retrievable storage;
an encryption arrangement for encrypting the data structure associated with the unique machine-readable identifier by an encryption method which prevents subsequent alteration of stored information on the associated data structure; and
an adding arrangement for adding the associated data structure to at least one data package, the at least one data package comprising at least one of:
at least one piece of composition information for the packaging material; and
at least one piece of recycling information for the packaging material.

28. An arrangement comprising at least two semi-finished packages for a method, the method comprising detachably attaching, non-destructively, at least one unique machine-readable identifier to a package comprising at least one packaging material;
associating the at least one unique machine-readable identifier with a unique data structure for data packages on a digitally retrievable storage;
encrypting the data structure associated with the unique machine-readable identifier by an encryption method which prevents subsequent alteration of stored information on the associated data structure; and
adding the associated data structure to at least one data package, the at least one data package comprising at least one of:
at least one piece of composition information for the packaging material; and
at least one piece of recycling information for the packaging material;
wherein at least one unique machine-readable identifier is non-destructively detachably attached to each semi-finished package; and
wherein the at least two semi-finished packages are contiguous.
